(19) United States
(12) Patent Application Publication
(10) Pub. No.: US 2002/0077924 A1
(43) Pub. Date: Jun. 20, 2002

(54) System and method for marketing products and services

(76) Inventors: Jonathan Spetner, St. Louis, MO (US); Thomas J. Klein, St. Louis, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 09/742,862

(22) Filed: Dec. 20, 2000

(51) Int. Cl. G06F 17/60

(52) U.S. Cl. 705/26

(57) ABSTRACT

A system for marketing goods and services over the Internet comprising a computer capable of accessing the Internet, a computer system capable of being accessed by the computer over the Internet, the computer system for providing a plurality of screens to the computer once the computer accesses the computer system with such screen providing information relating to products or services being offered for sale by the computer system and a phone number for contacting a representative of the computer system, a telephone connection between a user of the computer and a representative of the computer system, a user and a representative being able to talk to each other during the providing of the screens, and the computer system further comprising means for controlling operation of the computer once the telephone connection has been established.

### BACKGROUND OF THE INVENTION

This invention relates to a system and method for marketing products and services and more particularly to a networked system and method for marketing products and services over the Internet.

The Internet, which is a global network of interconnected computers, is being used to market and sell goods and services to geographically dispersed customers and vendors. The customers use a computer graphical interface or web browser to locate and interact with a vendor's website. Vendors, which are hosting websites on the Internet, are very diverse and include vendors of products such as automobile, clothing, real estate, mail order, and electronic and computer equipment. Other vendors advertise their services over the Internet and examples of services which are being offered include legal advice, insurance rate comparisons, and financial services. As can be appreciated, browsing various vendors' websites in search of information for goods and services is efficient and productive in that it eliminates the time consuming process of physically visiting a vendor's location or store. However, even though it is easier to browse a vendor's website in search of goods and services, it still may be advantageous to have some human intervention when making a purchasing decision. For example, it may be desirable to speak to a knowledgeable salesperson to answer questions concerning price, quantity, color, availability of products, or whether there are any special promotions not listed on a website.

A common interface at a vendor's website is the use of a shopping cart in which to place items to be purchased. The shopping cart may be reviewed at various intervals during a shopping session in order to determine what items are really desired. When checking out of a vendor's website, certain information needs to be entered on various screens. It has been estimated that more than fifty percent of all shopping carts which are filled are later abandoned. One reason is that there is no salesperson to help the customer make a purchasing decision.

As the number of goods and services on the Internet increase, it would be advantageous to provide a customer with the ability to talk to a representative at a vendor's website to discuss various purchasing options. Additionally, although websites can provide a customer with a plethora of information, there are times when it would be desirable to obtain guidance or to discuss options in further detail than what can be presented on a screen. Further, it has been found that the information presented at a website is so voluminous that a visitor to the website may have difficulty in navigating the website. In this situation, it would be desirous to be able to contact a representative of the website to gain some guidance as to where information may be effectively found or located within the website.

The present invention is designed to obviate and overcome many of the disadvantages and shortcomings associated with present systems and methods which are used to sell goods or services over the Internet. In particular, the present invention is a system and method which provides for human intervention when connected to a website in order to easily discuss product and services features and to sell goods or services over the Internet. Moreover, the system of the present invention can be employed to construct a website which includes personnel for consulting with potential customers about various goods or services offered at a website. Further, it would be advantageous to incorporate the ability to contact a representative of a website for the representative to discuss various features of the products or services being offered and for the representative to display various different prices or quotes which are dependent upon information being discussed and displayed at the website.

### SUMMARY OF THE INVENTION

In one form of the present invention, a system for marketing goods and services over the Internet comprises a computer capable of accessing the Internet, a computer system capable of being accessed by the computer over the Internet, the computer system for providing a plurality of screens to the computer once the computer accesses the computer system with such screen providing information relating to products or services being offered for sale by the computer system and a phone number for contacting a representative of the computer system, a telephone connection between a user of the computer and a representative of the computer system, a user and a representative being able to talk to each other during the providing of the screens, and the computer system further comprising means for controlling operation of the computer once the telephone connection has been established.

In another form of the present invention, a system for marketing goods and services over the Internet comprises a customer computer capable of accessing the Internet, the customer computer comprising a display, a customer telephone, a vendor computer system capable of being accessed by the customer computer over the Internet, the vendor computer system for providing a series of screens to the customer computer once the customer computer accesses the vendor computer system with such screens providing information relating to products or services being offered for sale by the vendor computer system and a phone number for contacting a representative of the vendor computer system, a vendor telephone, a telephone connection between the customer telephone and the vendor telephone, a customer and a representative being able to talk to each other during the providing of the screens, and the vendor computer system further comprising means for controlling operation of the customer computer once the telephone connection has been established.

In yet another form of the present invention, a method of marketing goods and services over the Internet comprises the steps of providing a website of a vendor over the Internet, allowing a customer to access the website to view screens relating to goods and services being offered by the vendor, displaying a phone number for a customer to call to obtain further information relating to goods or services being offered by the vendor, connecting a telephone call between the customer and a representative of the vendor, and conferencing the customer and the representative together for the representative to control the operation of the screens which are presented to the customer.

In light of the foregoing comments, it will be recognized that a principal object of the present invention is to provide a system and method for marketing goods and services over the Internet.

A further object of the present invention is to provide a system and method of marketing goods or services over the Internet which is of simple construction and design and which can be easily employed with highly reliable results.

Another object of the present invention is to provide a system and method of marketing goods and services over the Internet that increases the amount of goods or services which are sold at a website.

A further object of the present invention is to provide a system and method of marketing goods and services over the Internet which allows for the use of hand held devices and wireless devices.

Another object of the present invention is to provide a system and method of marketing goods and services over the Internet which allows a representative to control the operation of a vendor website to present various screens to a customer and to generate a quote based upon discussed or displayed information.

Yet another object of the present invention is to provide a system and method of marketing goods and services over the Internet which allows a representative to control what is provided on the screen of a customer's computer during a discussion or presentation.

A still further object of the present invention is to provide a system and method of marketing goods and services over the Internet which reduces the number of salespersons required for effectively selling goods and services.

These and other objects and advantages of the present invention will become apparent after considering the following detailed specification in conjunction with the accompanying drawings, wherein:

### BRIEF DESCRIPTION OF THE DRAWINGS

FIG. 1 is a block diagram of a system for marketing goods and services over the Internet constructed according to the present invention;

FIG. 2 is a flow chart diagram illustrating the operation of the system for marketing goods and services over the Internet which was shown in FIG. 1;

FIG. 3 is an illustration of a display screen which may be presented to a customer computer;

FIG. 4 is another illustration of a display screen which may be presented to a customer computer;

FIG. 5 is an illustration of a display screen which may be presented on a computer associated with the vendor computer system;

FIG. 6 is an illustration of a display screen which may be presented to a customer computer;

FIG. 7 is another flow chart diagram illustrating the operation of the system for marketing goods and services over the Internet according to the present invention; and

FIG. 8 is another preferred embodiment of a system for marketing goods and services over the Internet constructed according to the present invention.

### DETAILED DESCRIPTION OF THE PREFERRED EMBODIMENTS

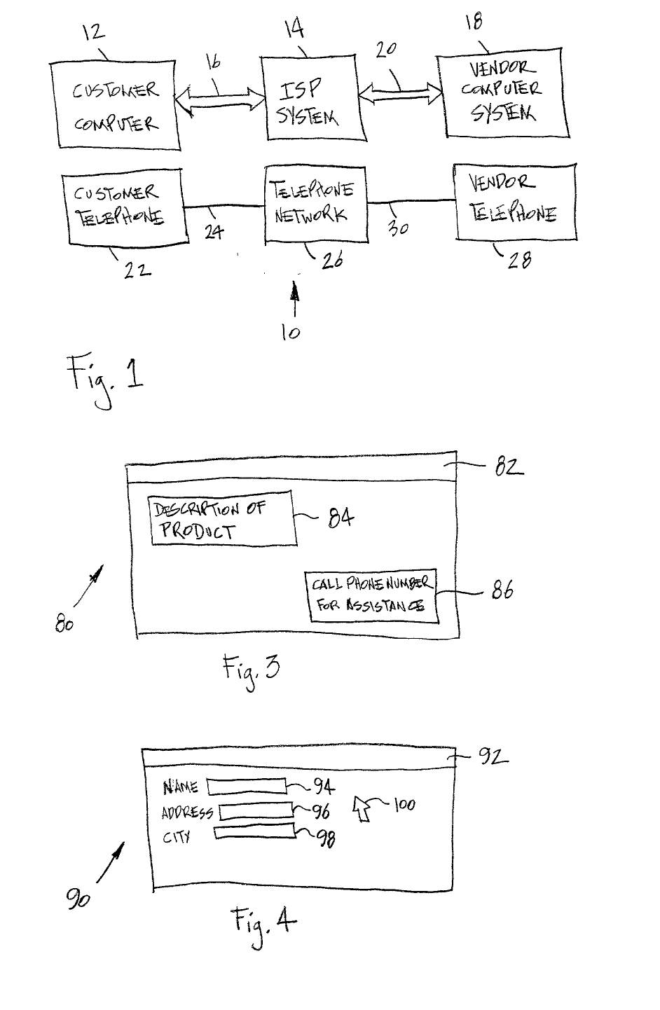

Referring now to the drawings, wherein like numbers refer to like items, number 10 identifies a preferred embodiment of a system for marketing goods and services over the Internet constructed according to the present invention. With reference now to FIG. 1, the system 10 is shown to comprise a computer or a customer computer 12 which is capable of being connected to the Internet. For example, the customer computer 12 may be connected to an Internet Service Provided (ISP) system 14 via a connection 16, such as a telephone line. The ISP system 14 is further capable of connecting a website being hosted by a vendor computer system 18 to the customer computer 12. The ISP system 14 is connected to the vendor computer system 18 by a connection 20, such as a telephone line connection. Other examples of the connections 16 or 20 are cable, ISDN, T1, DSL, or other types of broadband connections. The customer computer 12 is allowed access to the vendor computer system 18 through the ISP system 14 by use of a commonly available web browser or similar software package. The vendor computer system 18 is capable of hosting a website which presents various pages or screens to the customer computer 12. A customer operating the customer computer 12 is able to interact with the website being hosted by the vendor computer system 18. In particular, a customer may be presented with various screens with such screens presenting information concerning products and services being offered for sale by a vendor.

The system 10 further comprises a customer telephone 22 which is connected via a telephone line 24 to a telephone network 26. The telephone network 26 is in turned connected to a vendor telephone 28 by a telephone line 30. The website being hosted by the vendor computer system 18 may also have a screen which indicates to a customer that a telephone call or conference may be initiated by a customer in order to talk to a person at the vendor computer system 18. For example, a customer may be provided with a telephone number to call which will connect a customer with a person or representative at the vendor computer system 18. A customer operating the customer telephone 22 is able to talk or interact with a salesperson or personnel at the vendor telephone 28. Although the ISP system 14 and the telephone network 26 are illustrated as being separate, it is also possible and contemplated that the ISP system 14 and the telephone network 26 may be integrated. Additionally, the connections 16, 20, 24, and 30 may also be integrated.

Although not shown, the customer computer 12 may be a personal computer that is connected to the ISP system 14 by use of a modem. The customer computer 12 may include a keyboard, display, mouse, and associated software for browsing the Internet. For example, two commonly available software packages that may be used to search the Internet are Netscape Navigator or Microsoft Internet Explorer. Additionally, the vendor computer system 18 may include one or more personal computers or servers which are connected to the Internet via a modem or a plurality of modems. Each of the computers within the vendor computer system 18 may include a keyboard, display, mouse, and associated software for conferencing the vendor computer system 18 with the customer computer 12, as will be explained.

With reference now to FIG. 2, a flow chart 50 of the operation of the system 10 is depicted. As an initial step 52, a customer has begun a search on the Internet for a particular product by using a search engine or by typing in a particular website address. In a step 54, the customer has found a website which satisfies a search query or the entry of a website address. In the step 54, the customer is capable of reviewing various pages or screens which are a part of the website. At some point during the review process the customer may want further information about a product or products and the customer will be instructed to initiate a telephone conference to a call center or a direct dial telephone number. This step is indicated as a block 56 in the flow chart 50. Once the telephone conference is initiated, a representative will answer the call, step 58, and begin a conversation with the customer concerning information about the searched product. At this point and at a step 60, the representative will initiate a conference between the customer computer 12 and a computer within the vendor computer system 18. The representative is capable of capturing control of the customer computer 12 by use of conferencing software which is part of the vendor computer system 18. An example of a software program which may be used to capture control and to conference both the customer computer 12 and a computer which is part of the vendor computer system 18 is software available from Placeware. Once the customer computer 12 and the computer at the vendor computer system 18 are conferenced together, the representative can control what is displayed on the customer computer 12. For example, after a discussion as to what the customer may desire, the representative will provide required information to the display of the customer computer 12. Conducting the conference is shown as a step 62 in the flow chart 50. Once a purchasing decision has been made by the customer, the representative can then input the necessary information to finalize the purchase or transaction and this is indicated in a step 64. After the purchase has been made, both the telephone conference and the control of the customer computer 12 are terminated as is shown in a step 66 in the flow chart 50. As indicated in a step 68, the customer may then either continue browsing on the Internet or may turn off the customer computer 12. The above discussion is also applicable to the marketing of services.

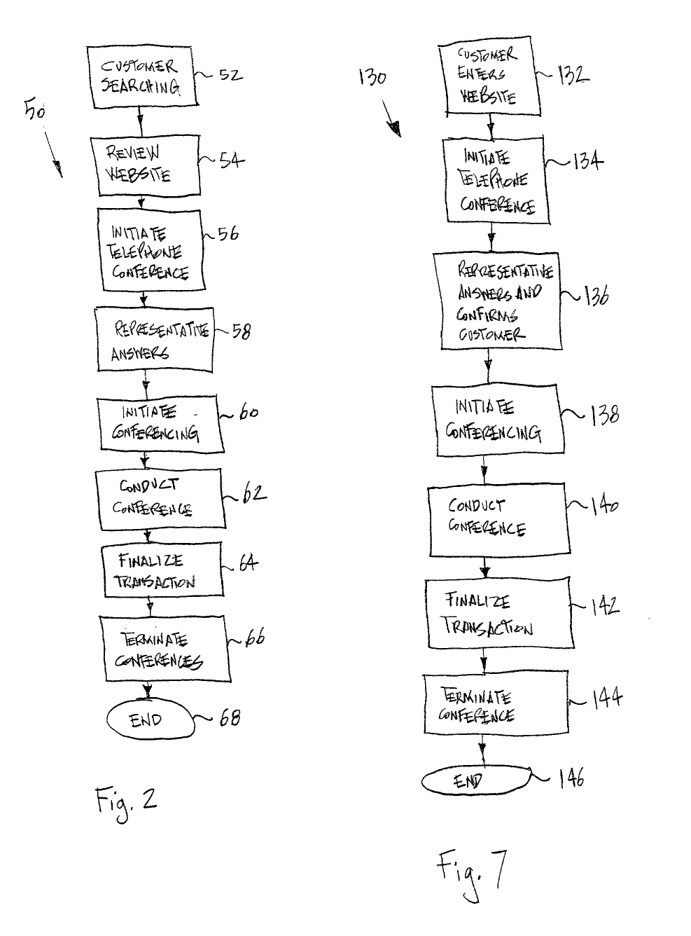

FIG. 3 illustrates a screen or web page 80 which may be presented on the display of the customer computer 12 when a customer has entered a website and has selected a particular product. The web page 80 includes a tool bar 82 which is part of the web browser software. A portion or box 84 of the page 80 includes information concerning the product about which the customer may request information. Additionally, on the web page 80 is a box 86 which contains information relating to a phone number which the customer may call to speak with personnel at the vendor computer system 18 about the product selected. As discussed above, once the phone call is initiated, a representative at the vendor computer system 18 is able to conference the customer computer 12 with a computer at the vendor computer system 18. Once this is accomplished, the customer and the representative are able to talk about the product selected and the representative is able to present other information, screens, or web pages to the customer.

Referring now to FIG. 4, another web page 90 is shown which illustrates a screen which is provided to the customer computer 12 by the vendor computer system 18. In particular, when the vendor computer system 18 conferences with the customer computer 12, the vendor computer system 18 is able to take over control of the screen of the customer computer 12. The web page 90 includes a tool bar 92, however, the ability of the customer to operate or use the tool bar 92 may be suspended during the conference. The web page 90 is shown to include a NAME box 94 in which the representative at the vendor computer system 18 is capable of typing the name of the customer once the customer informs the representative during the phone conference. An ADDRESS box 96 and CITY box 98 are also included in the web page 90 and again the representative is able to type this information in so that it appears on the display of the customer computer 12. The web page 90 also has a cursor 100 which is under the control of the representative during the conferencing of the customer computer 12 and the computer at the vendor computer system 18. After the conference is complete or has ended, control of the customer computer 12 is provided back to the customer. Further, the screen, which will be presented to the customer at the customer computer 12, will be the home page of the website of the vendor computer system 18. The customer is then able to continue to navigate about the website of the vendor computer system 18 or to leave the site and search other pages or sites on the Internet.

As can be appreciated, the representative, once the conference has been initiated, is capable of presenting any number of different screens to the customer. For example, if the customer informs the representative that there was another product that the customer was interested in purchasing, the representative could easily navigate to that web page which presents the product. Further, if there is a large amount of information presented on a particular web page, the representative could point out a particular section by use of the cursor 100. The representative could even highlight specific text for the customer to view. Additionally, as the representative types information into the various boxes 94, 96, and 98, the customer could comment on whether the entered information is accurate.

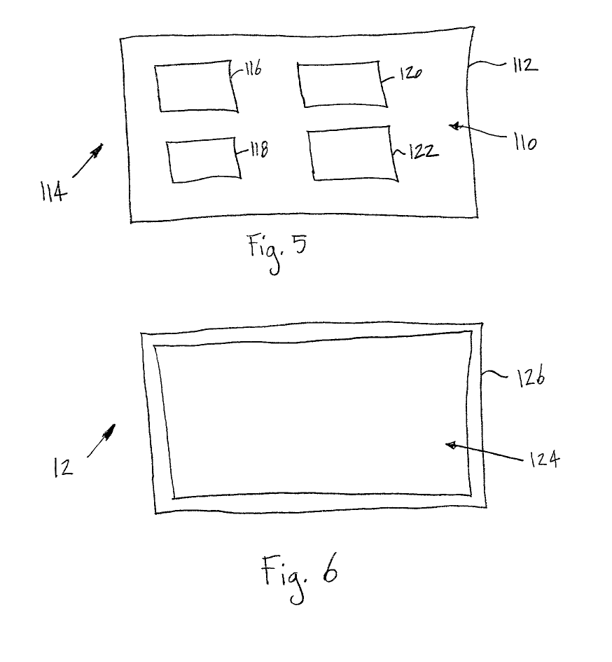

FIG. 5 depicts a screen 110 on a monitor 112 of a computer 114 which is associated with or part of the vendor computer system 18. The screen 110 may include several different boxes or windows 116, 118, 120, and 122 which may be sized to fit within the screen 110. Box 116 may contain information such as notes or a script which the personnel at the vendor computer system 18 needs to go over with a customer. Box 118 may contain information concerning rate schedules. The box 120 may be a representation of pages or screens which are available on the website of the vendor computer system 18. Further, the box 122 may contain a software application, such as a word processor program. The boxes 116-122 may contain other information that may be available to personnel operating the computer 114 of the vendor computer system 18. For example, the boxes 116-122 may include audio files or video files which may be selected by the personnel and also the conferencing software which is used to capture the customer computer 12. Additionally, one of the boxes 116-122 may contain a screen which is representative of what is being presented to the customer computer 12.

With reference now to FIG. 6, a screen 124 on a monitor 126 of the customer computer 12 is shown. The screen 124 may be one of the boxes 116-122 which is being displayed on the screen 110 of the computer 114. In essence, if box 116 is the screen or window which personnel at the vendor computer system 18 want to appear at the customer computer 12, then such box 116 will be displayed on the screen 124 of the customer computer 12. Personnel at the computer 114 are able to move into the box 116 whatever information is to be presented in the screen 124 of the customer computer 12. In this manner, an effective presentation and discussion may be implemented. Additionally, personnel can be performing other operations on the computer 114, such as determining a sales price or a discount, prior to this be presented to the customer computer 12. In effect, the computer 114 is capable of multitasking or performing multiple operations while the customer computer 12 is only being provided what the personnel at the computer 114 wants such customer computer 12 to view.

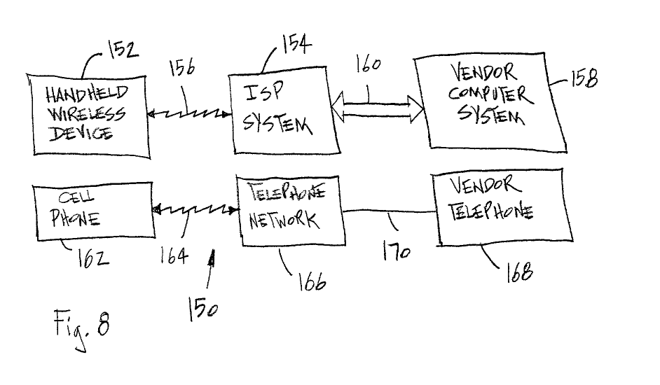

Another application of the present system 10 is illustrated in a flow chart 130 shown in FIG. 7. In this particular application, the customer is an employee of a company which has contracted with an insurance agency for specific employee benefits. The website of the insurance agency and its associated computer equipment is an example of the vendor computer system 18. The customer uses a customer computer 12 to go directly to the website of the insurance agency. For example, the employee's handbook will have the website address for the insurance agency which has the contract with the company. The flow chart 130 starts at a step 132 in which the customer has entered or connected to the website of the insurance agency. Once the customer is connected to the website of the insurance agency, the customer is instructed to call a telephone number to initiate a telephone conference with a representative of the insurance agency. This step is shown in a box 134. Next, at a step 136, the representative questions the customer for an employee number or other identifying information. For example, prior to the customer calling, the company provides the insurance agency with specific information related to the employee with such information including employee number, social security number, address, phone number, age, and location of the employee. This information may be stored on a database associated with or part of the vendor computer system 18. This information is also used to set up a conference between the customer computer 12 and the computer of the vendor computer system 18. For example, the customer computer 12 may have a specific designation which allows the conferencing software to easily connect the customer computer 12 to the computer of the vendor computer system 18. Once the representative initiates a conference, as is indicated in a step 138, the representative calls this information up from the database and this information is shown on the display of the customer computer 12. The customer would then confirm this information or if there were any errors this would be brought to the attention of the representative for correction. At this point, the representative is capable of controlling the presentation to the customer and a conference is conducted, as shown in a step 140. The presentation may consist of the representative showing the customer the various employee benefits available. Further, the presentation may include other products or services which may be available to the customer. The representative would be able to show the customer various screens or web pages which would include information and pricing of the various available products or services. At some point during the presentation, a transaction is finalized and this is indicated by a step 142. Once the transaction is finalized, a step 144 is encountered in which the conference is terminated. Control of the display of the customer computer 12 is provided back to the customer and the process is ended at a step 146.

Another preferred embodiment of a system for marketing goods and services over the Internet 150 constructed according to the present invention is illustrated in FIG. 6. The system 150 comprises a handheld wireless device 152 such as an PDA (personal data assistant) type device. The device 152 is an example of a personal computer which is small and compact in design and includes a screen, input keys, memory, and a modem for accessing the Internet. The device 152 is capable of being connected to the Internet by use of an ISP system 154 through the use of a wireless connection 156. The ISP system 154 is further capable of connecting to a website being hosted by a vendor computer system 158. The ISP system 154 may be connected to the vendor computer system 158 by a conventional land line connection 160 or the connection 160 may even be wireless. The device 152 is allowed to access the vendor computer system 158 by use of a commonly available web browser or similar software package. The vendor computer system 158 is capable of hosting numerous websites or one website which presents virtual venues or various web pages to the device 152. A customer operating the device 152 is able to interact with the various websites or web pages being hosted by the vendor computer system 158.

The system 150 further comprises a cell phone device 162 that is connected via a wireless connection 164 to a telephone network 166. The telephone network 166 is in turned connected to a vendor telephone 168 via a telephone line 170. A customer operating the device 152 may be provided with a telephone number to call which will connect a customer with a person at the vendor computer system 158. A customer operating the cell phone 162 is able to talk or interact with a salesperson or personnel at the vendor telephone 168.

The system 150 operates in the following manner. A customer begins searching the Internet for a particular product by using a search engine or by typing in a particular website address on the device 152. Once a website which satisfies a search inquiry or the entry of a website address is found the customer views or navigates around the website. At some point during the review process the customer may want further information about a product or products and the customer will be instructed to initiate a telephone conference by use of the cell phone 162. When the telephone conference is initiated, a representative will answer the call at the vendor telephone 168 and begin a conversation with the customer concerning information about the searched product. At this point the representative will initiate a conference between the device 152 and a computer within the vendor computer system 158. The representative is capable of capturing control of the device 152 by use of conferencing software which is part of the vendor computer system 158. Once the device 152 and the computer at the vendor computer system 158 are conferenced together, the representative can control what is presented or displayed on the screen of the device 152. In particular, after discussing what the customer is looking for, the representative will provide the required information to the display of the device 152. When a purchasing decision has been made by the customer, the representative can then input the necessary information to finalize the purchase or transaction. If no other purchase is to be made then both the telephone conference and the control of the device 152 are terminated. It is to be understood that the system 150 encompasses both the use of the device 152 and the cell phone 162 at the same time in order for a conversation between the customer and the representative to take place and for various web pages to be displayed on or presented to the device 152.

It is also possible that the device 152 and the cell phone 162 may be an integrated device. For example, a cell phone may be capable of connecting to the Internet and have a display or a PDA type device incorporated within the cell phone.

As discussed previously, an example of a software program which is used to capture control of another computer and to conference, for purposes of example, both the customer computer 12 and a computer which is part of the vendor computer system 18 is software available from Placeware. Capturing control of the customer computer 12 may encompass three different levels of control. A first level may include the capability of placing or sending displays from the computer which is part of the vendor computer system 18 to the display of the customer computer 12. As discussed above, other information may be sent to the customer computer 12 which includes audio files, video clips, and presentations such as slide show type presentations. In this sense, the computer which is part of the vendor computer system 18 is only sending data, information, or web pages to the customer computer 12 and is not completely controlling the customer computer 12. A second level of control may consist of controlling the browser program on the customer computer 12. In this instance, customer service could show how to navigate about a web site. A third level of control may include capturing complete control of the customer computer 12.

The system 10 or 150 of the present invention may also be employed to help a customer navigate around a website. For example, a customer may be capable of querying the website to find specific information or products. However, at times, due to the large amount of information at a website, it would be beneficial to talk to someone who knows the website in detail. In this particular application, the website would present a screen which would include information on how to contact a representative who could assist the customer in navigating around the website. The customer would then initiate the telephone call and the representative at the vendor computer system would initiate conferencing between the customer computer and the vendor computer system. The representative would ask the customer what the customer attempting to locate at the website. Once this information is provided, the representative would present the particular screen or web page which contains the requested information. In this manner, the system 10 or 150 allows a person or customer not familiar with a website to be able to contact a representative in order for the representative to navigate to a particular web page within a website.

From all that has been said, it will be clear that there has thus been shown and described herein a system and method for marketing goods and services over the Internet which fulfills the various objects and advantages sought therefor. It will become apparent to those skilled in the art, however, that many changes, modifications, variations, and other uses and applications of the subject system and method for marketing goods and services over the Internet are possible and contemplated. All changes, modifications, variations, and other uses and applications which do not depart from the spirit and scope of the invention are deemed to be covered by the invention, which is limited only by the claims which follow.

What is claimed is:

1. A system for marketing goods and services over the Internet comprising:
a computer capable of accessing the Internet;
a computer system capable of being accessed by the computer over the Internet, the computer system for providing a plurality of screens to the computer once the computer accesses the computer system with such screen providing information relating to products or services being offered for sale by the computer system and a phone number for contacting a representative of the computer system;
a telephone connection between a user of the computer and a representative of the computer system, a user and a representative being able to talk to each other during the providing of the screens; and
the computer system further comprising means for controlling operation of the computer once the telephone connection has been established.

2. The system of claim 1 wherein the controlling means comprises a software program capable of conferencing the computer and the computer system together.

3. The system of claim 1 wherein the computer system comprises a software program for generating a quote based upon discussed or displayed information.

4. The system of claim 1 wherein the computer system comprises a computer having a display, the display for selecting which of the screens will be presented to the computer accessing the Internet.

5. The system of claim 1 wherein the telephone connection is a wireless connection.

6. The system of claim 1 wherein the computer is a hand held computer.

7. The system of claim 1 wherein a representative is capable of inputting information to be displayed on the computer capable of accessing the Internet.

8. The system of claim 1 wherein the computer system further comprises a computer having a display, the display having a first window which is representative of a screen being provided to the computer and a second window containing other information.

9. A system for marketing goods and services over the Internet comprising:
a customer computer capable of accessing the Internet, the customer computer comprising a display;
a customer telephone;
a vendor computer system capable of being accessed by the customer computer over the Internet, the vendor computer system for providing a series of screens to the customer computer once the customer computer accesses the vendor computer system with such screens providing information relating to products or services being offered for sale by the vendor computer system and a phone number for contacting a representative of the vendor computer system;
a vendor telephone;
a telephone connection between the customer telephone and the vendor telephone, a customer and a representative being able to talk to each other during the providing of the screens; and
the vendor computer system further comprising means for controlling operation of the customer computer once the telephone connection has been established.

10. The system of claim 9 wherein the controlling means comprises a software program capable of conferencing the customer computer and the vendor computer system together.

11. The system of claim 9 wherein the vendor computer system comprises a software program for generating a quote based upon discussed or displayed information.

12. The system of claim 9 wherein the vendor computer system comprises a computer having a display, the display for selecting which of the screens will be presented to the customer computer.

13. The system of claim 9 wherein the telephone connection is a wireless connection.

14. The system of claim 9 wherein the customer computer is a hand held computer.

15. The system of claim 9 wherein the customer computer is a wireless hand held computer.

16. The system of claim 9 wherein a representative is capable of inputting information to be displayed on the customer computer.

17. The system of claim 9 wherein the vendor computer system further comprises a computer having a display, the display having a first window which is representative of a screen being provided to the customer computer and a second window containing other information.

18. A method of marketing goods and services over the Internet comprising the steps of providing a website of a vendor over the Internet, allowing a customer to access the website to view screens relating to goods and services being offered by the vendor, displaying a phone number for a customer to call to obtain further information relating to goods or services being offered by the vendor, connecting a telephone call between the customer and a representative of the vendor, and conferencing the customer and the representative together for the representative to control the operation of the screens which are presented to the customer.

19. The method of claim 18 further comprising the step of a representative inputting information to be presented to a customer.

20. The method of claim 18 further comprising the step of finalizing a purchase of goods or services.
